(19) United States
(12) Patent Application Publication
(10) Pub. No.: US 2018/0142837 A1
(43) Pub. Date: May 24, 2018

(54) Grease Gun with Locking Coupler and Hose-Securing Element

(71) Applicant: Isles Bridge LLC, Lyme, NH (US)

(72) Inventors: Justin S. Boren, Norwich, VT (US); Russell L. Barnes, Lyme, NH (US)

(21) Appl. No.: 15/612,447

(22) Filed: Jun. 2, 2017

Related U.S. Application Data
(60) Provisional application No. 62/425,791, filed on Nov. 23, 2016.

(51) Int. Cl. F16N 21/02; F16N 3/12

(52) U.S. Cl. CPC F16N 21/02; F16N 3/12

(57) ABSTRACT

A grease gun having a delivery hose with a locking coupler is provided with a hose-securing element that is attached with respect to a hose base end. The hose-securing element has a nipple portion that matches the external dimensions of a Zerk-type grease nipple, allowing the coupler to be securely engaged with the nipple portion in the same manner as it would engage a grease nipple. Engaging the coupler with the hose-securing element forms the hose into a loop to prevent it from flopping about, and allows the grease gun to be suspended or carried via the looped hose. The hose-securing element can be attached to a reservoir body or portion of a pump mechanism of the grease gun, or directly to the hose base end. The hose-securing element can be surrounded by a protective cup to contain residual grease on the coupler.

### FIELD OF THE INVENTION

The present invention relates to grease guns used to forcibly inject lubricating grease into a mechanism vie a standardized fitting.

### BACKGROUND

Grease guns are employed to forcibly inject grease or similar lubricant into mechanisms needing periodic lubrication. The grease gun has a body, which serves as a reservoir for grease, and a pump mechanism that is operated by the user to force grease through a delivery hose. The hose terminates in hose free end equipped with a hose coupler, which is designed to mate to a standardized nipple on the piece of machinery to be lubricated. The Zerk-type fitting has been standardized with a fixed external geometry, and the hose coupler is designed to secure onto the Zerk-type nipple to allow grease to be forced therethrough into the mechanism, and to thereafter be manually disengaged from the nipple.

Traditionally, hose couplers have been designed such that disengagement is accomplished by the user applying an off-axis force to the hose coupler. This scheme has a disadvantage in that the hose coupler may be inadvertently dislodged if the hose is bumped. To overcome this limitation, locking couplers for Zerk-type grease nipples have been developed, such as the hose couplers taught in U.S. Pat. No. 8,955,544, and U.S. Publication 2015/0115601, both references being incorporated herein by reference. Such locking couplers are characterized in that, once engaged with the nipple, they cannot be disengaged by off-axis forces. Instead, a release element on the coupler must be manually operated to allow the coupler to disengage, after which the coupler can be removed by withdrawing it in an axial direction.

In all cases, the hose coupler is subject to becoming soiled with grease, and in storage the flexibility of the hose makes it difficult to control the hose to avoid contaminating surrounding surfaces with the grease. Additionally, if the pump mechanism is inadvertently activated while in storage, grease released from the hose coupler may contaminate surrounding objects.

### SUMMARY

The present invention provides a grease gun that includes a hose-securing element that overcomes the deficiencies of the prior art. The grease gun again has a body provided with a reservoir for containing grease, and which terminates in a body head end and a body tail end. A grease-expelling means such as a pump mechanism is attached to the body and can be operated by the user to force grease from the reservoir through a delivery hose that is connected with respect to the body head end; when a pump mechanism mounted onto the body head end is employed as the grease-expelling means, the hose base end is typically connected directly to the pump mechanism. Typically, the pump mechanism is operated by moving a lever. In many grease guns, the lever is pivoted relative to the body to operate the pump. In other grease guns, the pump mechanism has a “pistol grip” configuration where the lever is pivoted relative to a stationary grip. Alternative grease-expelling means, such as electrically-powered or pneumatically-powered devices, could be employed; in such cases, the device may operate by acting as a pump that draws grease from the reservoir or may act to apply pressure to the grease contained in the reservoir to force it into the delivery hose.

The hose terminates at a hose base end, which is connected with respect to the body head end, and a hose free end, which is fitted with a locking coupler. The locking coupler extends along a longitudinal axis, and is configured to lockably engage a conventional Zerk-type grease nipple when advanced axially thereover. The locking coupler is designed such that it cannot be released by off-axis motion, as is done to release conventional grease couplers, but rather has a manually-activated release mechanism which must be activated to unlock the locking coupler from the grease nipple. Examples of suitable locking couplers are taught in U.S. Pat. No. 8,955,544 and U.S. Publication 2015/0115601, both incorporated herein by reference.

To secure the hose free end when the grease gun is not in use, a hose-securing element is provided that has a nipple portion that matches the external dimensions of a Zerk-type grease nipple. This configuration of the nipple portion of the hose-securing element allows the locking coupler to be securely engaged with the nipple portion, in the same manner that the coupler would engage a grease nipple. The hose-securing element is attached onto the grease gun so as to be secured with respect to the hose base end, and thus the hose-securing element allows the hose free end, which is fitted with the locking coupler, to be secured relative to the hose base end, forming a loop in the hose. This not only secures the free end of the hose, preventing it from flopping about, but also allows the grease gun to be suspended or carried via the looped hose. Preferably, the hose-securing element is closed, with no passage therethrough, and thereby also serves to block release of grease from the coupler in the event that the pump mechanism is inadvertently operated.

The hose-securing element can be attached to the body, to an element of the pump mechanism, or directly to the hose base end. To accommodate any particular location, the hose-securing element may have the external configuration of a straight Zerk-type grease nipple, or could have the external configuration of an angled grease nipple; however, since the hose-securing element typically does not include a passage therethrough, its overall form has fewer constraints; only the nipple portion that is engaged by the locking coupler need be matched to the configuration of the Zerk-type grease nipple. Because the locking coupler frequently becomes contaminated with grease, it is preferred to attach the hose-securing element at a location away from areas of the grease gun that are typically handled when in use, to reduce the likelihood of grease getting on the hands of the user. Examples of such preferred locations are on the body head end, and on an element of the pump mechanism that is in close proximity to the pump head end. Further protection from grease can be attained by surrounding the hose-securing element with a protective cup that is sized to accept the locking coupler while allowing access to the release mechanism; the cup serves to contain any residual grease on the locking coupler.

### BRIEF DESCRIPTION OF FIGURES

FIGS. 1 and 2 illustrate a grease gun that forms one embodiment of the present invention. In this embodiment, the grease gun has a lever-type pump mechanism and a hose-securing element is attached to a body head end by a bracket that is affixed to the body head end, and into which the hose-securing element is threadably attached. FIG. 1 shows the grease gun before engaging a locking coupler with the hose-securing element, while FIG. 2 illustrates the grease gun when the coupler has been releasably, lockably engaged with the hose-securing element to secure a hose free end and form the hose into a closed loop.

FIGS. 3 and 4 illustrate a grease gun that forms another embodiment of the present invention, in this case having a “pistol grip” type pump mechanism. In this embodiment, a hose-securing element is attached to a link element of the pump mechanism, the link element in turn being pivotally attached to the body head end. Again, FIG. 3 shows the grease gun before engaging a locking coupler with the hose-securing element, leaving a delivery hose free to move about, while FIG. 4 illustrates the grease gun when the hose free end has been secured by engaging a locking coupler with the hose-securing element.

FIG. 5 is a partial view of a grease gun that forms another embodiment of the present invention. In this embodiment, a hose-securing element is housed in a cup that is sized to accept a portion of a locking coupler, providing greater protection from grease for the user.

### DETAILED DESCRIPTION

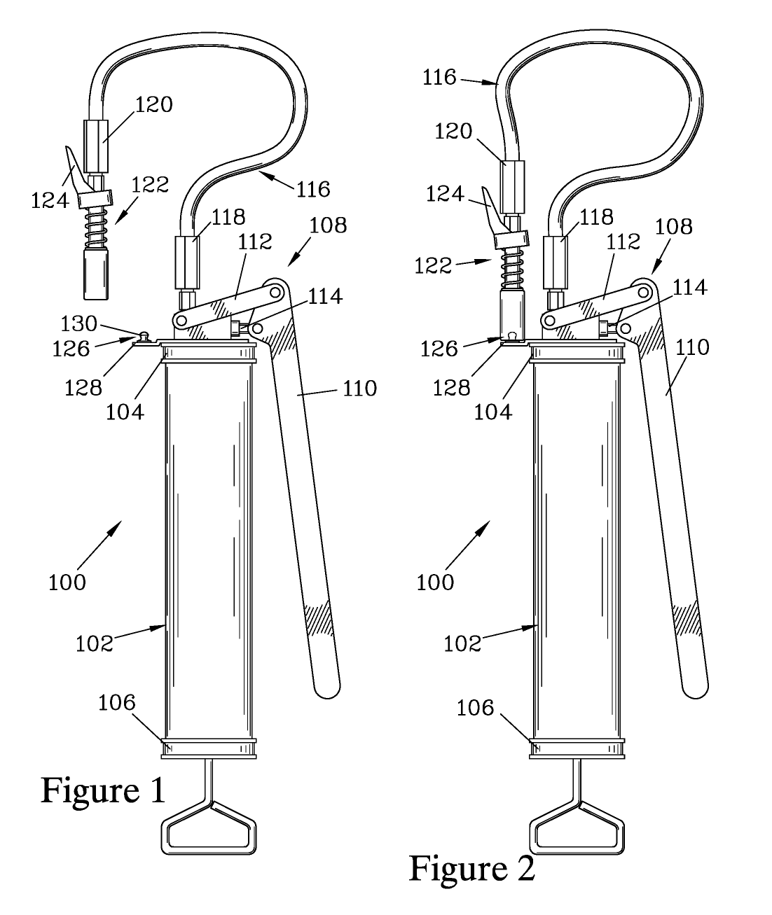

FIGS. 1 and 2 illustrate a grease gun 100 having a body 102 that terminates in a body head end 104 and a body tail end 106. The body 102 is hollow to provide a reservoir in which grease can be contained. A pump mechanism 108 is fitted onto the body head end 104, and in this embodiment is a lever-type pump having a lever 110 pivotably connected to the body head end via a pump link member 112 and a pump shaft 114.

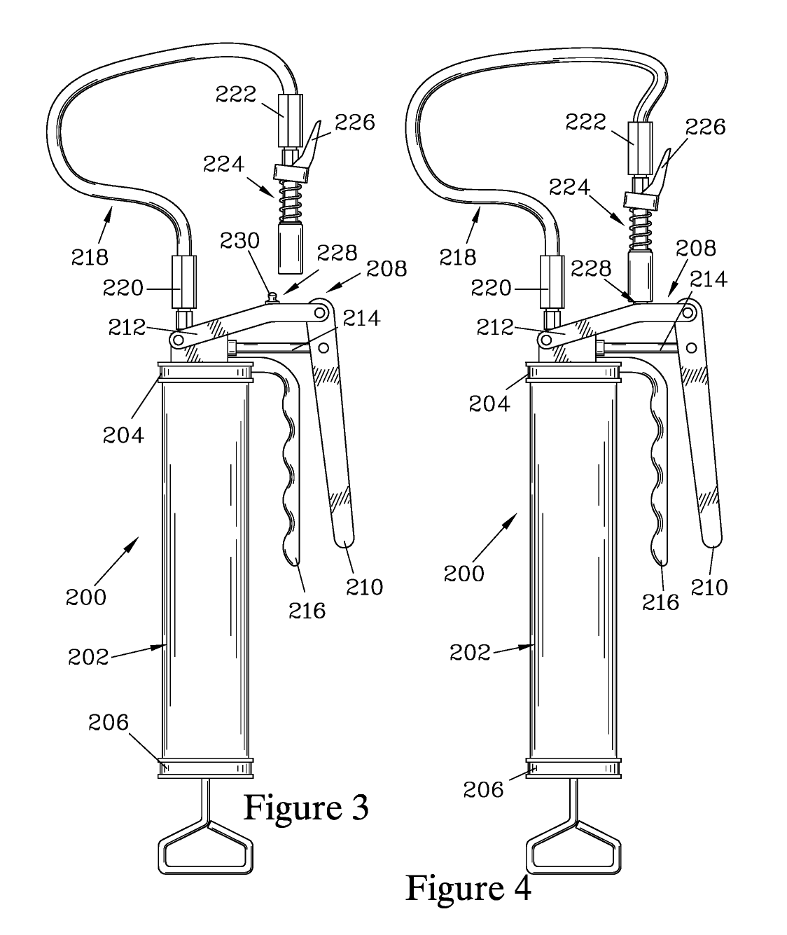

The grease gun 100 has a delivery hose 116, which terminates in a hose base end 118 and a hose free end 120. The hose base end 118 incorporates a swivel, and attaches to the pump mechanism 108, while the hose free end 120 is fitted with a locking coupler 122. The locking coupler 122 is designed to lockably, releasably engage a conventional Zerk-type grease nipple; when so attached, the locking coupler 122 can only be released by activating a release lever 124. The locking coupler 122 illustrated is similar to those taught in U.S. Pat. No. 8,955,544, incorporated herein by reference; the engagement and release of the locking coupler and Zerk-type grease nipple are illustrated in FIG. 3 of the '544 patent. Another such locking coupler that could be employed is taught in U.S. Publication 2015/0115601, incorporated herein by reference; the engagement and release of the locking coupler and grease nipple are illustrated in FIGS. 2 & 3, 12 & 13 of the '601 publication.

A hose-securing element 126 is provided, and in the grease gun 100 the hose-securing element 126 is threadably mounted to a bracket 128 that in turn is affixed to the body head end 104. Since the hose base end 118 is attached to the pump mechanism 108 that in turn is affixed to the body head end 104, mounting the hose-securing element 126 to the bracket 128 serves to attach the hose-securing element 126 with respect to the hose base end 118. While shown threaded, the hose-securing element 126 could be soldered, brazed, adhered, or otherwise attached to the bracket 128, of could be formed as an integral part thereof.

The hose-securing element 126 has a nipple portion 130 (shown in FIG. 1) having an external configuration matching that of a Zerk-type grease nipple, and thus the locking coupler 122 can releasably, lockably engage the nipple portion 130 in the same manner that it would engage a Zerk-type grease nipple. As shown in FIG. 1, the locking coupler 122 is not engaged with the hose-securing element 126, and thus the hose free end 120 can move freely and may contaminate nearby objects with grease residing on the locking coupler 122. Additionally, the delivery hose 116 may become entangled with other objects. FIG. 2 illustrates the grease gun 100 when the locking coupler 122 has been engaged with the hose-securing element 126, and thus the hose free end 120 is secured relative to the hose base end 118, preventing free movement of the hose free end 120 and forming a loop in the delivery hose 116, which can be used to conveniently hang the grease gun 100 for storage or to carry the grease gun 100.

FIGS. 3 and 4 illustrate a grease gun 200 that again has a body 202 terminating in a body head end 204 and a body tail end 206, with a pump mechanism 208 fitted to the body head end 204. In the grease gun 200, the pump mechanism 208 is a “pistol grip” style pump, having a lever 210 pivotably connected to the body head end 204 via a pump link member 212 and a pump shaft 214, and which pivots relative to a fixed grip member 216 attached to the body head end 204.

The grease gun 200 has a delivery hose 218, terminating in a hose base end 220 and a hose free end 222, the hose free end 222 being provided with a locking coupler 224 having a release lever 226.

A hose-securing element 228 (best shown in FIG. 3) is provided, and in this embodiment is mounted to the link member 212 of the pump mechanism 208. This placement attaches the hose-securing element 228 with respect to the hose base end 220, since the hose base end 20 is attached to the pump mechanism 208. The locking coupler 224 can be engaged with a nipple portion 230 of the hose-securing element 228, to secure the hose free end 222 with respect to the hose base end 220 and form a closed loop in the delivery hose 218, as shown in FIG. 4.

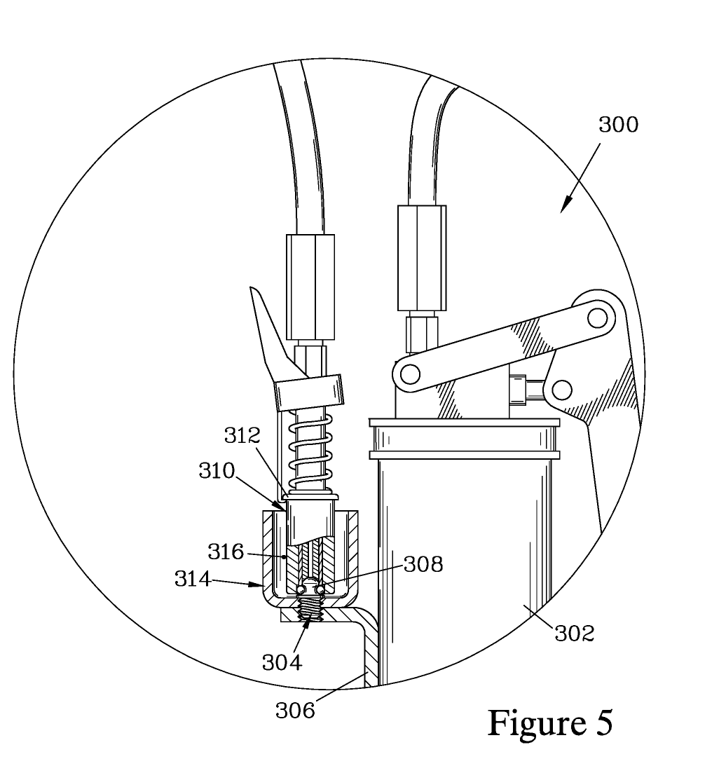

FIG. 5 illustrates a portion of the grease gun 300 that provides additional protection for the user and surrounding area from contamination by grease. The grease gun 300 has a body 302, to which a hose-securing element 304 is mounted via a bracket 306. The hose-securing element 304 again has a nipple portion 308, which can be lockably engaged by a locking coupler 310 having a release mechanism 312. The locking coupler 310 illustrated is similar to those taught in U.S. Publication 2015/0115601, where the release mechanism 312 is a collar that is retracted to unlock from a grease nipple; alternative locking couplers could be employed.

The hose-securing element 304 is surrounded by a cup 314 mounted to the bracket 306 and having an interior space 316. The interior space 316 is configured to accept a portion of the locking coupler 310 to allow the locking coupler 310 to securely attach onto the nipple portion 308, and the cup 314 serves to contain any residual grease on the locking coupler 310 when the grease gun 300 is not in use. The cup 314 is configured to allow the user access to the locking mechanism 312 to allow the user to release the locking coupler 310 from the hose-securing element 304 in order to use the grease gun 300.

While the novel features of the present invention have been described in terms of particular embodiments and preferred applications, it should be appreciated by one skilled in the art that substitution of materials and modification of details can be made without departing from the spirit of the invention.

1. A grease gun comprising:
a body containing a reservoir for grease, terminating in a body head end and a body tail end;
a grease-expelling means attached to said body;
a delivery hose having a hose base end, which is connected with respect to said body head end, and a hose free end,
said grease-expelling means being activatable to force grease from said reservoir through said delivery hose;
a locking coupler attached to said hose free end and configured to lockably engage a conventional Zerk-type grease nipple, and said locking coupler having a manually-activated release mechanism which can be activated to unlock said locking coupler from the grease nipple to allow removal therefrom; and
a hose securing element attached with respect to said hose base end, said hose securing element having a nipple portion having the external dimensions of a Zerk-type grease nipple.

2. The grease gun of claim 1 wherein said hose securing element is formed as a solid piece with no passage through the nipple portion.

3. The grease gun of claim 2 wherein said grease-expelling means is a pump mechanism attached to said body head end, and said hose securing element is attached to said pump mechanism.

4. The grease gun of claim 2 wherein said hose securing element is attached to said body head end.

5. The grease gun of claim 2 further comprising:
a cup attached to said hose-securing element and having a cup interior space in which said hose-securing element resides, said interior space being configured to accept said locking coupler therein and leaving said release mechanism exposed.

6. A grease gun comprising:
a body containing a reservoir for grease, terminating in a body head end and a body tail end;
a pump mechanism attached to said body head end;
a delivery hose having a hose base end, which is connected with respect to said body head end, and a hose free end,
said pump mechanism being activatable to force grease from said reservoir through said delivery hose;
a locking coupler attached to said hose free end and configured to lockably engage a conventional Zerk-type grease nipple, said locking coupler having a manually-activated release mechanism which can be activated to unlock said locking coupler from the grease nipple to allow removal therefrom; and
a hose securing element having a nipple portion having the external dimensions of a Zerk-type grease nipple, said hose-securing element being affixed with respect to at least one of:
said body head end,
a component of said pump mechanism, and
said hose base end.

7. The grease gun of claim 6 wherein said hose securing element is formed as a solid piece with no passage through the nipple portion.

8. The grease gun of claim 7 further comprising:
a cup attached to said hose-securing element and having a cup interior space in which said hose-securing element resides, said interior space being configured to accept said locking coupler therein and leaving said release mechanism exposed.
